(19) United States
(12) Patent Application Publication
(10) Pub. No.: US 2025/0013469 A1
(43) Pub. Date: Jan. 9, 2025

(54) CONTROLLING WHICH MEMORY SOURCE IS UTILIZED FOR FETCHING INSTRUCTIONS BY A PROCESSOR OF A MICROCONTROLLER

(71) Applicant: Microchip Technology Incorporated, Chandler, AZ (US)

(72) Inventor: Ivar Holand, Trondelag (NO)

(21) Appl. No.: 18/763,534

(22) Filed: Jul. 3, 2024

Related U.S. Application Data
(60) Provisional application No. 63/511,833, filed on Jul. 3, 2023.

(51) Int. Cl. G06F 9/32; G06F 9/30; G06F 13/16

(52) U.S. Cl. CPC G06F 9/321; G06F 9/30047; G06F 13/1668

(57) ABSTRACT

A method may include executing, by a processor of a microcontroller system, instructions fetched from a first memory of the microcontroller system; setting the processor of the microcontroller to execute instructions from a second memory of the microcontroller at least partially responsive to a state of an internal signal of the microcontroller, and executing, by the processor of the microcontroller system, instructions fetched from the second memory of the microcontroller system.

### CROSS-REFERENCE TO RELATED APPLICATION

This application claims the benefit under 35 U.S.C. § 119 (e) of U.S. Provisional Patent Application Ser. No. 63/511,833 filed Jul. 3, 2023, the contents and disclosure of which is hereby incorporated herein in its entirety by this reference.

### FIELD

One or more examples relate, generally, to microcontroller systems. One or more examples relate to controlling which memory source is used by a processor of a microcontroller for executing instructions, and architecture to facilitate such control.

Microcontrollers are and embedded systems are utilized in a variety of operational contexts and for a variety of applications.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram depicting a system having a microcontroller architecture to allow selective fetching of instructions (e.g., processor executable instructions, without limitation) from respective ones of multiple distinct memories, in accordance with one or more examples.

FIG. 2 is a block diagram of a system in accordance with one or more examples.

FIG. 3 is a datapath diagram of a logic circuit for controlling which memory source (e.g., SRAM or Flash memory, without limitation) is used by a processor of a microcontroller system for executing instructions, in accordance with one or more examples.

FIG. 4 is a flow diagram depicting an example process to selectively fetch instructions from respective ones of multiple distinct memories, in accordance with one or more examples.

FIG. 5 is a flow diagram depicting an example process to set the processor of the microcontroller to execute instructions from a second memory of the microcontroller, in accordance with one or more examples.

FIG. 6 illustrates an example process to reset the processor of the microcontroller system to fetch and execute instructions from the first memory, in accordance with one or more examples.

FIG. 7 illustrates an example process to set up program code for fetching and executing from a data memory, in accordance with one or more examples.

FIG. 8 is a block diagram of a circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

As used herein, the terms “assert,” “de-assert” and derivatives thereof used in reference to a pin, means, respectively, to assert or de-assert a signal associated with the pin (e.g., a signal specifically assigned to the pin or a signal to which the pin is specifically assigned, without limitation).

One or more examples relate, generally to a microcontroller that includes multiple storage devices (storage devices are also referred to herein as “memories” or individually as a “memory”), which may, as a non-limiting example, store program code or data. Some or a totality of addresses within respective address spaces of the memories are identical. A processor (e.g., CPU, without limitation) of the microcontroller may selectively fetch instructions (e.g., as part of an instruction cycle, without limitation) from either memory. Circuitry of the processor can enable and disable fetch operations from the respective memories. In one or more examples, one of the memories is a Flash memory and another one of the memories is a Static Random Access Memory (SRAM). In these examples, the Flash memory is utilized by the microcontroller as a program memory, and the SRAM is utilized by the microcontroller as a data memory.

Fetching instructions from Flash memory may limit CPU speed. An option to execute from SRAM may allow for faster execution of code (e.g., as compared to execution from Flash memory).

To move between executing safely and efficiently from Flash memory to executing from SRAM, a register of the microcontroller may store one or more addresses associated with the starting instruction of a program stored at the SRAM (a program stored at the SRAM referred to herein as a “SRAM program”). The SRAM program may be at least a portion of a program (include some or a totality of instructions of the program, without limitation) stored at the Flash memory (the program stored at the Flash memory referred to herein as a “Flash program”). In one or more examples, the SRAM program may have been copied (e.g., by the CPU, without limitation) from a portion of the Flash program. In one or more examples, an internal signal of the microcontroller system may be utilized to disable execution of instructions from Flash memory and enable execution of instructions from SRAM.

In one or more examples, a value of the internal signal may be set by a CPU instruction. Additionally or alternatively, in one or more examples, a value of the internal signal may be set by a peripheral device of the microcontroller.

In this manner (i.e., via the internal signal), SRAM execution may be controlled via one or more registers. The SRAM location for the starting instruction of the SRAM code may be written to a register. An interrupt-like behavior is triggered by the processor by, as a non-limiting examples, writing to a control bit, a logic circuit, or executing an instruction. When the interrupt is triggered, the processor's program counter is updated with the SRAM address stored in the register and circuitry of the processor enables instruction fetch from the SRAM (and disables instruction fetch from the Flash memory). Upon initiation of an instruction cycle at the processor, the next instruction loaded is from the SRAM address. The processor may return to executing instructions from the Flash memory at a later time.

SRAM memory is typically much faster than Flash memory. So, in one or more examples, a faster clock may be utilized by the processor when executing from SRAM memory than when executing from Flash memory. Conversely, a slower clock may be utilized by a processor when executing from Flash memory than when executing from SRAM memory. As non-limiting examples, execution from Flash memory may be utilized during low power or sleep modes of the microcontroller and execution from SRAM memory may be utilized during normal or less-power sensitive modes of the microcontroller.

By way of non-limiting example: cither as part of the startup routine, or during runtime, executable instructions can be copied from Flash memory to SRAM at specified location by a user (e.g., an executing process, without limitation). The user writes the SRAM address location for the first instruction of the code to a register in an “SRAM execution peripheral.” The user enables an SRAM execution feature by setting a flag or control bit or writing a command. Alternatively, it can write a timed sequence before executing either: a) executing a CPU instruction “execute SRAM,” or b) write a strobe bit in a register in the “SRAM execution peripheral.”

This causes an interrupt to the CPU moving the program counter to the given location in SRAM. Next instruction the CPU executes will be the instruction located at the given SRAM location. After this the CPU continues to execute code according to the code in SRAM. The code should be self-contained, i.e., calls to code located in flash should be ignored, a flag, and pending interrupt should be set so upon return from SRAM a fault interrupt handler is executed, for debug purposes. Other interrupts are also ignored as long a SRAM execution is ongoing. On return the CPU executes a similar instruction as return from interrupt and continues to execute code from the next line in flash after “execute SRAM” instruction, or strobe bit to the “SRAM execution peripheral.”

In one or more examples, the internal signal is a dedicated software triggered interrupt that an interrupt handler executes from SRAM memory.

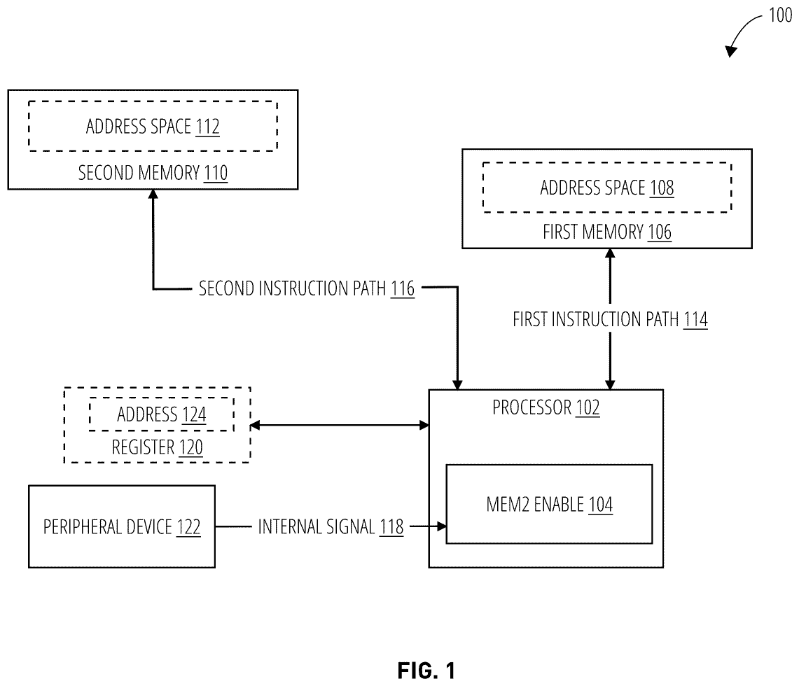

FIG. 1 is a block diagram depicting a microcontroller system 100 having a microcontroller architecture to allow selective fetching of instructions from respective ones of multiple distinct memories, in accordance with one or more examples. In various examples, microcontroller system 100 includes circuitry to control which memory source (e.g., SRAM or Flash memory, without limitation) is used by a processor of microcontroller system 100 to execute instructions.

Microcontroller system 100 includes a processor 102, first memory 106, second memory 110, and peripheral device 122. microcontroller system 100 may also include an optional register 120, discussed below.

Processor 102 orchestrates the fetching and execution of instructions. The processor 102 interacts with two distinct memory components: first memory 106 and second memory 110.

First memory 106 may be Flash memory utilized as the primary program memory where the main codebase is stored. Flash memory is non-volatile, retaining its data even when power is removed, making it ideal for storing firmware and application code.

Second memory 110 is SRAM utilized as data memory for temporary storage during program execution. SRAM is faster than Flash memory, allowing for quicker access and execution of code segments that have been transferred from the Flash memory. As discussed herein, second memory 110 may also be selectively utilized as a program memory.

Address space 108 and address space 112 are distinct memory address ranges for first memory 106 and second memory 110, respectively. Processor 102 may access instructions stored in these address spaces during execution cycles.

To manage the selective fetching of instructions, microcontroller system 100 includes a circuit, mem2 enable 104, which is responsible for enabling or disabling the fetching of instructions from second memory 110. This circuit, mem2 enable 104, allows processor 102 to switch between fetching instructions from first memory 106 and second memory 110 based on, as non-limiting examples, operational context. performance requirements, or the operational state of microcontroller system 100.

First instruction path 114 and second instruction path 116 represent the routes (e.g., physical routes, logical routes, or both, without limitation) through which processor 102 fetches instructions from first memory 106 and second memory 110, respectively. First instruction path 114 and second instruction path 116 ensure that processor 102 can access the required instructions from the address space of the appropriate memory component.

Internal signal 118 controls which memory component (first memory 106 or second memory 110) is active for instruction fetching. In the specific non-limiting example depicted by FIG. 1, this control signal is generated within microcontroller system 100 and is utilized to enable or disable the fetching of instructions from the respective memories.

Internal signal 118 and mem2 enable 104 are functionally interdependent. In response to internal signal 118 being asserted or set to a first predetermined value, it triggers mem2 enable 104 to allow the processor to fetch instructions from second memory 110. Conversely, in response to internal signal 118 being de-asserted or set to a second predetermined value (different than the first predetermined value), mem2 enable 104 disables fetching from second memory 110, thus ensuring that instructions are fetched from first memory 106 instead.

Peripheral device 122 sets (e.g., asserts or sets to a value, without limitation) internal signal 118 to manage memory access dynamically. In some examples, peripheral device 122 may set the internal signal 118 based on certain operational conditions (e.g., observed by peripheral device 122 or indicated to peripheral device 122 by the processor 102 or another device (other device not depicted), without limitation), thereby enabling or disabling mem2 enable 104 and controlling which memory the processor 102 fetches instructions from. In some examples, peripheral device 122 may include a logic circuit to set a value of the internal signal, for example, in response to a write operation to a control bit of the logic circuit. As a non-limiting example, the logic circuit may be a strobe bit, an interrupt, or both.

In one or more examples, processor 102 may execute a command or instruction that triggers peripheral device 122 to set or clear (e.g., de-assert or set to a value, without limitation) internal signal 118. For instance, when processor 102 executes a specific instruction, peripheral device 122 receives a signal (e.g., a write signal from processor 102, without limitation), and in response to the signal peripheral device 122 sets internal signal 118 to enable fetching from second memory 110. Further, when processor 102 executes the same or a different instruction, peripheral device 122 receives a further signal and in response to the further signal peripheral device 122 clears internal signal 118 to disable fetching form second memory 110 and enable fetching from first memory 106. This mechanism ensures that the switching between first memory 106 and second memory 110 may be controlled programmatically (e.g., via execution of specific instructions executed by processor 102, without limitation).

In one or more examples, microcontroller system 100 may be designed such that the starting instruction in second memory 110 is always at a predefined, fixed address. Such a fixed address approach simplifies the design but may lack the flexibility offered by using a configurable register. Thus, additionally or alternatively to a predefined, fixed address, in or more examples the address of the starting instruction may be configurable to provide greater design flexibility, enabling different segments of code to be executed from SRAM as needed.

To implement a flexible address design, in one or more examples, microcontroller system 100 may include register 120. Register 120 is utilized to store an address associated with the starting instruction of a program (a program, a routine, a sub-routine, a set of interdependent instructions, without limitation) stored in second memory 110. Register 120 enables processor 102 to (quickly) switch to executing code from second memory 110/SRAM by updating its program counter with a specific address 124 stored in register 120.

In one or more examples, processor 102 may receive or read the address 124 from register 120 upon executing the instruction that triggers peripheral device 122 to set internal signal 118. For example, execution of the instruction may cause the address 124 to be sent to processor 102 or processor 102 to read the address 124.

For processor 102 to read register 120, microcontroller system 100 may include specific hardware support, such as a memory-mapped register interface or input/output (I/O) circuitry via which processor 102 may read address 124 from register 120. In such a case, register 120 may be a control or configuration register, designed to be accessible by the processor 102 for reading and writing operations.

In some cases, the program code stored second memory 110 may be initially stored in the first memory 106 and copied by processor 102 to address space 112 of second memory 110. Once the code is copied, processor 102 stores the address 124 of the starting instruction of this code in register 120. This enables register 120 to know where to begin fetching instructions from second memory 110. The ability of processor 102 to store address 124 of the starting instruction at register 120 provides flexibility, allowing the processor to dynamically manage which code segments are executed from second memory 110.

Alternatively, this entire setup can be pre-configured during a system initialization. In such a scenario, the program code may be stored at second memory 110 and the address of the starting instruction of the code stored at second memory 110 may be stored at register 120 during an initial setup phase. This approach simplifies runtime operations by ensuring that the necessary configuration is already in place when the system begins execution.

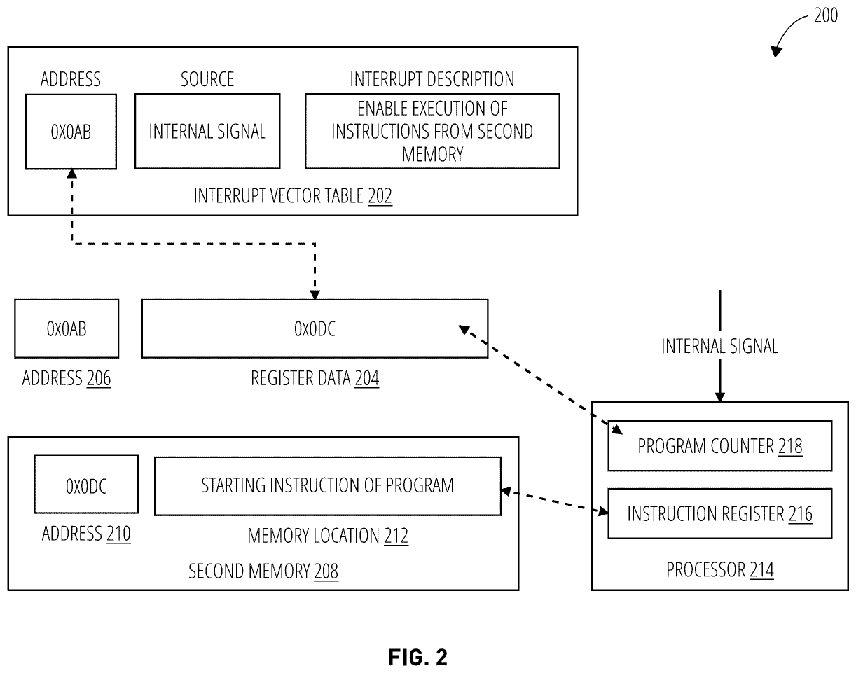

FIG. 2 is a block diagram of a system 200 in accordance with one or more examples. FIG. 2 depicts a non-limiting example of an extension of the microcontroller architecture depicted by FIG. 1, specifically, of interrupt handling and memory management.

System 200 includes processor 214, second memory 208, and interrupt vector table 202. Processor 214 is a non-limiting example of processor 102 and second memory 208 is a non-limiting example of second memory 110.

Interrupt vector table 202 is a logic circuit that implements a table to store the addresses of interrupt service routines. When an interrupt occurs, processor 102 utilizes interrupt vector table 202 to determine a starting address of an appropriate interrupt handler. This table is integral to the efficient handling of interrupts and ensures that the processor can quickly respond to external events. Interrupt vector table 202 includes example information for an interrupt vector for handling an interrupt triggered by assertion of the internal signal (e.g., internal signal 118) utilized to select instruction fetching between memories, discussed above. Information includes, but is not limited to, address, interrupt source, and interrupt description.

The address information is the starting address of the interrupt service routine (ISR) that should be executed when an interrupt triggered by the specified source occurs. In this example, the address ‘0x0AB’ is a memory-mapped address that refers to address 206 of a register (e.g., register 120 of FIG. 1, without limitation) storing, in register data 204, the address ‘0x0DC’ (e.g., address 210 and address 124 of FIG. 1) of the starting instructions of the program code at memory location 212 of second memory 208. In this manner, the switching of execution from instructions stored at first memory 106 to instructions stored at second memory 110 may be handled in a manner similar to initiating execution of an interrupt handling routine. By way of non-limiting example, an advantage of this approach is that processor 214 may return to the location in the program code stored in first memory 106 it was executing when the interrupt was triggered.

The source information describes the nature and source of the interrupt, here, internal signal 118. The interrupt description information provides detailed information on the type of interrupt, its priority, allowing the processor to handle the interrupt appropriately.

Program counter 218 of processor 214 is updated with addresses from interrupt vector table 202 or other sources, directing the processor 214 to the correct instruction to execute next. In a contemplated example, program counter 218 may be updated with the address stored at register data 204 when internal signal 118 is set.

Instruction register 216 holds (at least temporarily) the instruction currently being executed by the processor. It is part of the instruction cycle and is updated as the processor fetches new instructions from memory. When the microcontroller system start fetching instructions from second memory 208, instruction register 216 is updated with the “starting instruction of program” stored at memory location 212 of second memory 208.

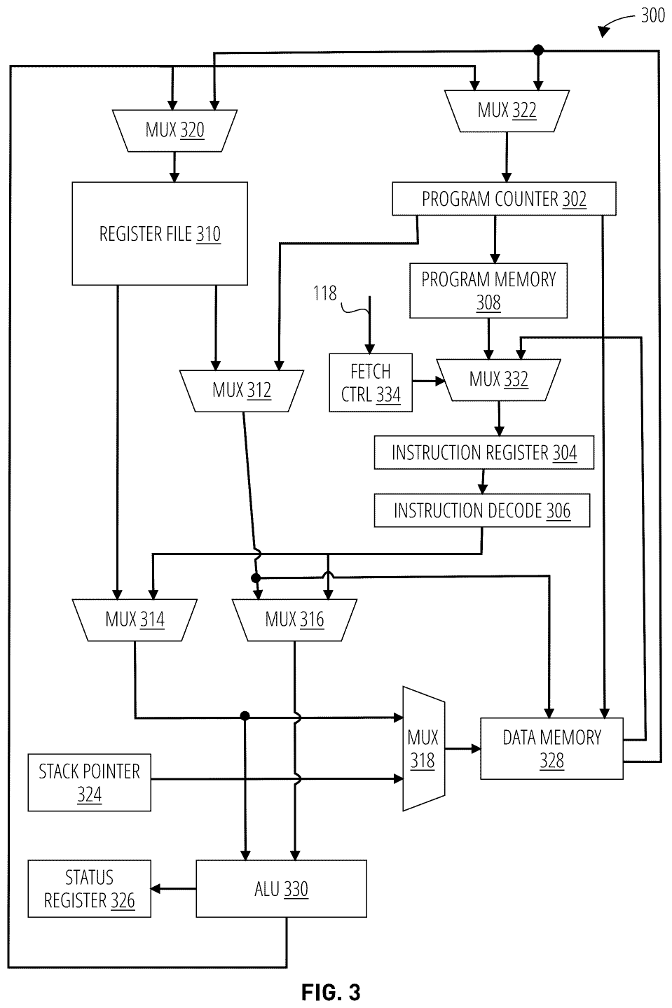

FIG. 3 is a datapath diagram of a logic circuit 300 for controlling which memory source (e.g., SRAM or Flash memory, without limitation) is used by a processor of a microcontroller system for executing instructions, in accordance with one or more examples. Signals for control, selection and timing are omitted from FIG. 3 to avoid unnecessarily obscuring the diagram. For example, signals for controlling selection between inputs of multiplexers (MUXs) are omitted from FIG. 3, though it may be assumed such signals may be utilized.

As noted above, logic circuit 300 may control the memory source (e.g., SRAM (data memory 328) or Flash memory (program memory 308), without limitation) utilized by a processor of a microcontroller system to fetch and execute instructions. Here, instruction register 304 may be fed the output of data memory 328 or program memory 308 via mux 332 at least partially based on the value of signal output by Fetch CTRL 334. In one or more examples, Fetch CTRL 334 may be or be controlled by mem2 enable 104 of FIG. 1, which enables or disables fetching from first memory 106 or second memory 110, as the case may be. Fetch CTRL 334 receive a signal that is, or that is at least partially based on, internal signal 118 generated at microcontroller system 100 and discussed above. Thus, the output of Fetch CTRL 334 may be controlled at least partially in response to internal signal 118.

Program counter 302 keeps track of the address of the next instruction to be executed by the processor. Program counter 302 receives input from the address lines coupled to an output of data memory 328 and potentially from control signals output from ALU 330 that dictate jumps or branches in the program execution. The output of data memory 328 and output of ALU 330 are received at inputs of mux 322, the output of which is provided to an input of program counter 302. Program counter 302 outputs the current address to the instruction fetch logic, pointing to the next instruction to be executed.

The instruction fetch logic includes program memory 308, Fetch CTRL 334, mux 332, instruction register 304, and instruction decode 306. Program memory 308 stores the program instructions to be fetched and executed by the processor. Program memory 308 outputs the instructions stored at specific addresses of instructions to be fetched pointed to by program memory 308. Mux 332 receives the instruction from program memory 308 and data from data memory 328, as well as control signals from Fetch CTRL 334 and outputs selected inputs as a formal instruction for the processor. Fetch CTRL 334 determines which input, instruction or data is selected. Instruction register 304 receives the instruction fetched from the memory address pointed to by the program counter 302 together with any data from the data memory 328 and stores it as the current, fetched instruction. Instruction register 304 outputs the fetched instruction to the instruction decode 306 and optionally other parts of the processor. Instruction decode 306 receives the fetched instruction from instruction register 304, decodes the fetched instruction, and generates control signals based on the decoded fetched instruction.

Register file 310 stores a set of registers for temporary data storage during execution. Register file 310 receives data inputs and control signals to determine which of its registers to read from or write to. It outputs data from the specified register or registers. The data and control signals that determine which registers the register file 310 reads from or writes to are at least partially based on the outputs of the data memory 328 and ALU 330, which are received as inputs of mux 320, the output of which is provided to an input (e.g., a register selection input, without limitation) of register file 310.

Mux 312 receives as inputs the output of register file 310 and program counter 302 and selectively output the inputs to mux 316. Mux 316 receives as inputs the output of mux 312 and instruction decode 306 and selectively provides the inputs as outputs to ALU 330.

Mux 314 receives as inputs the outputs of register file 310 and instruction decode 306 and selectively provides the inputs as outputs to ALU 330 and mux 318. In this manner, ALU 330 may receive the output of register file 310, the output of instruction decode 306, or the output of program counter 302, as well as other signals as may be required based on specific operating conditions. ALU 330 may also receive the output of status register 326, which holds and outputs current status indicators (e.g., flags or bits, without limitation) that indicate results of operations from various parts of the processor.

Mux 318 receives the output of mux 314, which selectively outputs the output of register file 310 or instruction decode 306, and the output of stack pointer 324, and provides the selected input as an output to data memory 328. Stack pointer 324 manages a stack memory used for function calls and local variables. Stack pointer 324 receives address inputs and control signals for stack operations (not depicted), and outputs a current stack address in response thereto.

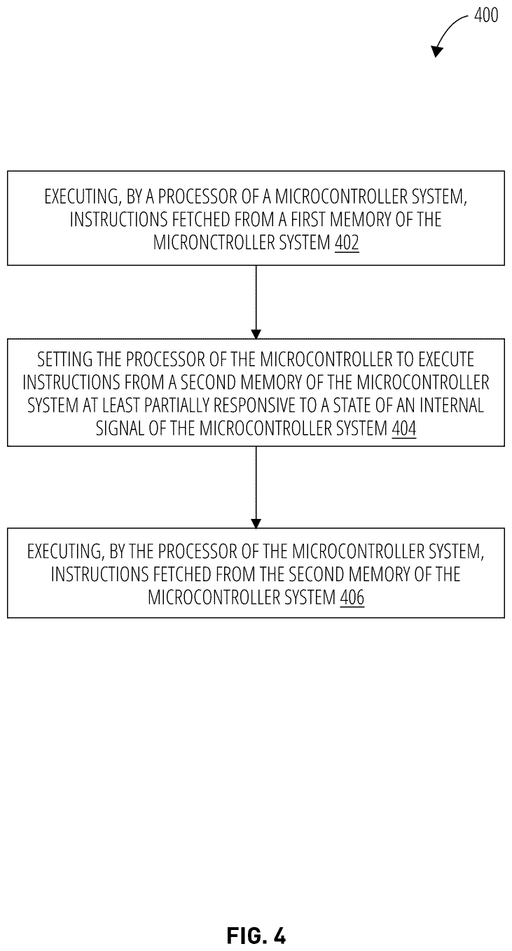

FIG. 4 is a flow diagram depicting an example process 400 to selectively fetch instructions from respective ones of multiple distinct memories, in accordance with one or more examples. Although the example process 400 depicts a particular sequence of operations, the sequence may be altered without departing from the scope of the present disclosure. For example, some of the operations depicted may be performed in parallel or in a different sequence that does not materially affect the function of the process 400. In other examples, different components of an example device or system that implements the process 400 may perform functions at substantially the same time or in a specific sequence. Some or a totality of operations of process 400 may be performed, as a non-limiting example, by microcontroller system 100, system 200, or logic circuit 300.

According to one or more examples, process 400 may include executing, by a processor of a microcontroller system, instructions fetched from a first memory of the microcontroller system at operation 402. In one or more examples, the first memory may be one of two or more memories at the microcontroller system. In one or more examples, the first memory may be a Flash memory utilized as a program memory of the microcontroller system. The instructions fetched from the first memory may be instructions of a program stored at the first memory.

According to one or more examples, process 400 may include setting the processor of the microcontroller to execute instructions from a second memory of the microcontroller at least partially responsive to a state of an internal signal of the microcontroller at operation 404. The internal signal is managed and generated entirely within the microcontroller, without external supervision or intervention. In one or more examples, the internal signal is generated by logic of the microcontroller system (e.g., at peripheral device of the microcontroller system). In some examples, setting of the internal signal may depend on specific instructions executed by the processor.

According to one or more examples, process 400 includes executing, by the processor of the microcontroller system, instructions fetched from the second memory of the microcontroller system at operation 406. The instructions are fetched from the second memory upon setting the processor to execute instructions from the second memory of the microcontroller in operation 404.

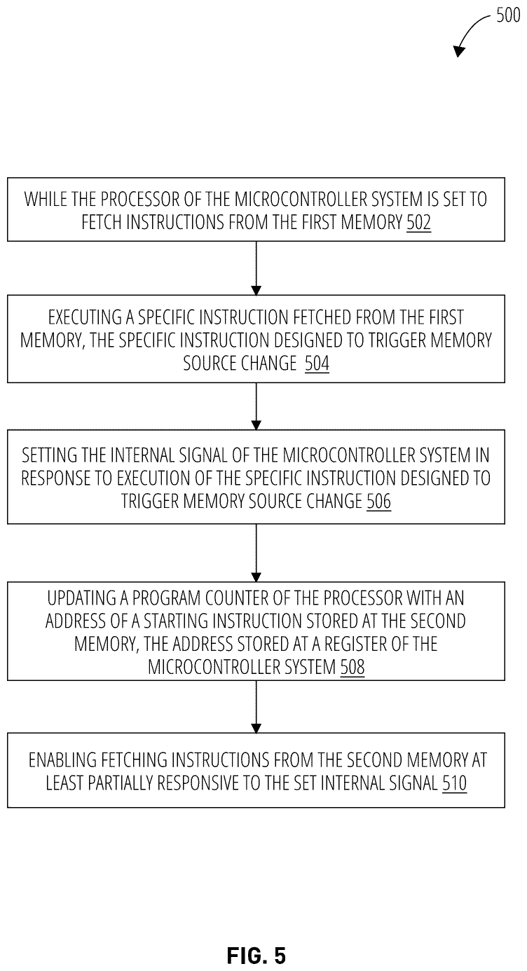

FIG. 5 is a flow diagram depicting an example process 500 to set the processor of the microcontroller to execute instructions from a second memory of the microcontroller, in accordance with one or more examples. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence. Some or a totality of operations of process 400 may be performed, as a non-limiting example, by microcontroller system 100, system 200, or logic circuit 300.

According to one or more examples, process 500 may include starting while the processor of the microcontroller system is set to fetch instructions from the first memory at operation 502. That the processor is set to fetch instructions from the first memory may be indicated by the processor actively fetching instructions from the first memory, by a value of the internal signal being associated with fetching instructions from the first memory, or by a state of mem2 enable (e.g., mem2 enable 104 of FIG. 1, without limitation), without limitation.

According to one or more examples, process 500 may include executing a specific instruction fetched from the first memory, the specific instruction designed to trigger a memory source change at operation 504. In one or more examples, the specific instruction may be an instruction of a program code stored at the first memory and being executed by the processor. In one or more examples, the instruction may be designed to trigger a memory source change because the instruction has been specifically implemented in the microcontroller's instruction set to initiate the process of setting instruction fetch from the second memory or switching between different memory sources. As a non-limiting example, the specific instruction may have a unique opcode that is recognized by the control logic of the microcontroller system as a command to change the memory source.

According to one or more examples, process 500 includes setting the internal signal of the microcontroller in response to execution of the specific instruction designed to trigger memory source change at operation 506. In one or more examples, settings the internal signal may include asserting the internal signal, setting the internal signal to a predetermined value. In one or more examples, the internal signal may be, or be associated with, an interrupt. In one or more examples, the internal signal may be, or be associated with, a strobe bit utilized to generate an interrupt and to indicate that data is ready to be read from a register of the microcontroller system, and more specifically, that an address of the starting instruction of the code stored at the second memory is ready to be read from a register of the microcontroller system. In one or more examples, assertion of the strobe bit (set to a high or active state) triggers a read of the register by the processor. In one or more examples, the internal signal may be generated by a peripheral of the microcontroller. In cases where the internal signal is implemented as a strobe bit, the strobe bit may be implemented at a peripheral of the microcontroller.

According to one or more examples, process 500 may include updating a program counter of the processor with an address of a starting instruction stored at the second memory, the address stored at a register of the microcontroller at operation 508. In one or more examples, the processor may update the program counter in response to assertion of the internal signal. In one or more examples, in the case where the internal signal is a strobe bit, assertion of the strobe bit may trigger a read of the address from the register or a data transfer of the address from the register to the program counter of the processor.

According to one or more examples, 500 may include enabling fetching instructions from the second memory at least partially responsive to the set internal signal at operation 510. The system comprises a process 500.

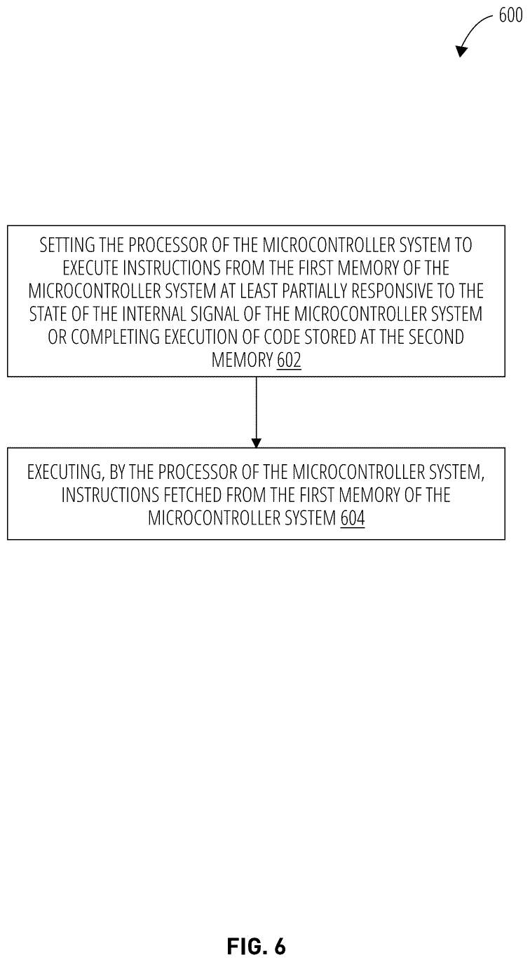

FIG. 6 illustrates an example process 600 to reset the processor of the microcontroller system to fetch and execute instructions from the first memory, in accordance with one or more examples. Although the example process 600 depicts a particular sequence of operations, the sequence may be altered without departing from the scope of the present disclosure. For example, some of the operations depicted may be performed in parallel or in a different sequence that does not materially affect the function of the process 600. In other examples, different components of an example device or system that implements the process 600 may perform functions at substantially the same time or in a specific sequence. Some or a totality of operations of process 400 may be performed, as a non-limiting example, by microcontroller system 100, system 200, or logic circuit 300.

According to one or more examples, the process 600 may include setting the processor of the microcontroller to execute instructions from the first memory of the microcontroller at least partially responsive to the state of the internal signal of the microcontroller or completing execution of code stored at the second memory at operation 602.

According to one or more examples, the process 600 may include executing, by the processor of the microcontroller system, instructions fetched from the first memory of the microcontroller system at operation 604. In this manner, when the processor finishes executing the program code stored at the second memory it may optionally revert back to fetching and executing instructions from the first memory.

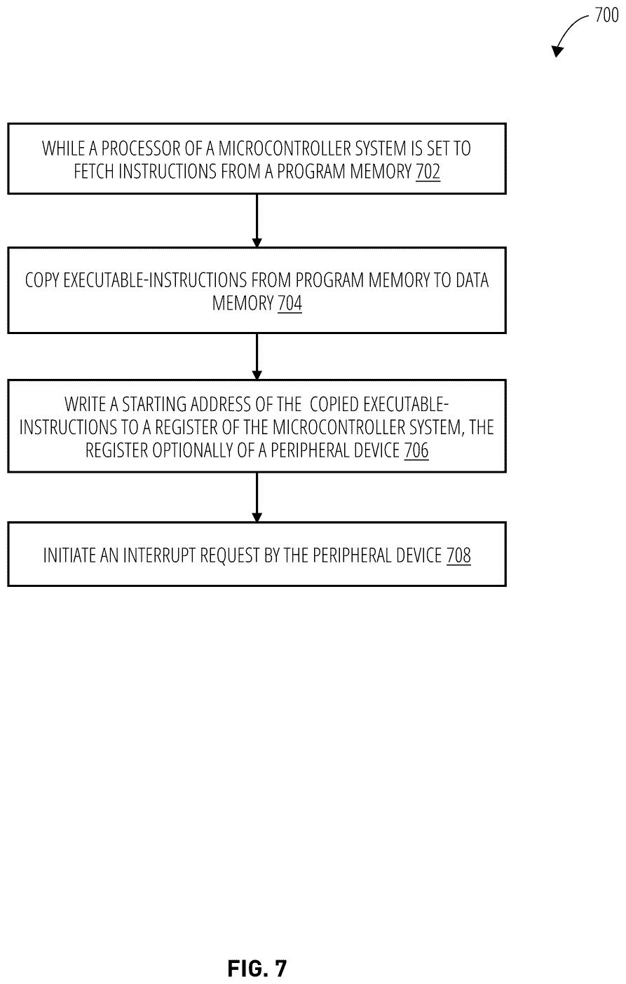

FIG. 7 illustrates an example process 700 to set up program code for fetching and executing from a data memory, in accordance with one or more examples. Although the example process 700 depicts a particular sequence of operations, the sequence may be altered without departing from the scope of the present disclosure. For example, some of the operations depicted may be performed in parallel or in a different sequence that does not materially affect the function of the process 700. In other examples, different components of an example device or system that implements the process 700 may perform functions at substantially the same time or in a specific sequence. Some or a totality of operations of process 700 may be performed, as non-limiting examples, by processor 102 or processor 214.

According to one or more examples, process 700 may include a processor of a microcontroller system is set to fetch instructions from a program memory at operation 702. The program memory may be a Flash memory as discussed above.

According to one or more examples, process 700 may include copying executable-instructions from program memory to data memory at operation 704. In one or more examples, the data memory may be an SRAM as discussed above. In some examples, the executable instructions may be copied in response to an instruction or command in program code stored at the program memory. Alternatively, copying of the executable instructions may occur during an initialization or set up phase of the microcontroller system.

According one or more examples, process 700 may include writing a starting address of the copied executable-instructions to a register of the microcontroller system, the register optionally of a peripheral device at operation 706.

According to one or more examples, process 700 may include initiating an interrupt request by the peripheral device at operation 708.

As discussed, additionally or alternatively, some or a totality of the setup of the program code and the address of the starting instruction at the data memory may be performed at configuration.

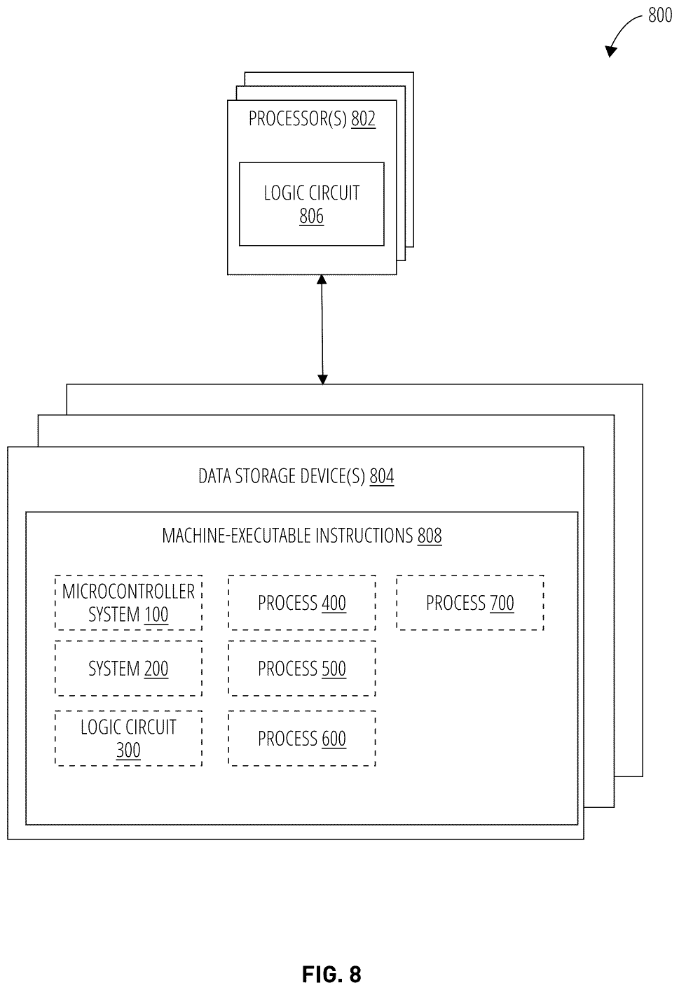

It will be appreciated by those of ordinary skill in the art that functional elements of examples disclosed herein (e.g., functions, operations, acts, processes, or methods) may be implemented in any suitable hardware, software, firmware, or combinations thereof. FIG. 8 illustrates non-limiting examples of implementations of functional elements disclosed herein. In some examples, some or all portions of the functional elements disclosed herein may be performed by hardware capable of carrying out the functional elements.

FIG. 8 is a block diagram of a circuitry 800 that, in some examples, may be used to implement various functions, operations, acts, processes, or methods disclosed herein. The circuitry 800 includes one or more processors 802 (sometimes referred to herein as “processors 802”) operably coupled to one or more data storage devices 804 (sometimes referred to herein as “storage 804”). The storage 804 includes machine-executable instructions 808 stored thereon and the processors 802 include logic circuit 806. The machine-executable instructions 808 information describes functional elements that may be implemented by (e.g., performed by) the logic circuit 806. The logic circuit 806 is adapted to implement (e.g., perform) the functional elements described by the machine-executable instructions 808. The circuitry 800, when executing the functional elements described by the machine-executable instructions 808, should be considered as special purpose hardware for carrying out functional elements disclosed herein. In some examples the processors 802 may perform the functional elements described by the machine-executable instructions 808 sequentially, concurrently (e.g., on one or more different hardware platforms), or in one or more parallel process streams.

When implemented by logic circuit 806 of the processors 802, the machine-executable instructions 808 adapts the processors 802 to perform operations of examples disclosed herein, including those discussed with respect to fetching instructions in a microcontroller. More specifically, with processor 102, first memory 106, second memory 110, register 120, or peripheral device 122; interrupt vector table 202, second memory 208, or processor 214; or the various combinational logic components of logic circuit 300.

Also by way of non-limiting example, the machine-executable instructions 808 may adapt the processors 802 to perform some or a totality of features, functions, or operations disclosed herein for switching memory source for fetching instructions in a microcontroller. More specifically, features, functions, or operations disclosed herein for one or more of: process 400, process 500, process 600, or process 700.

The processors 802 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable instructions 808 (e.g., software code, firmware code, hardware descriptions) related to examples of the present disclosure. It is noted that a general-purpose processor (may also be referred to herein as a host processor or simply a host) may be a microprocessor, but in the alternative, the processors 802 may include any conventional processor, controller, microcontroller, or state machine. The processors 802 may also be implemented as a combination of computing devices, such as a combination of a DSP and a microprocessor, a plurality of microprocessors, one or more microprocessors in conjunction with a DSP core, or any other such configuration.

In some examples the storage 804 includes volatile data storage (e.g., random-access memory (RAM)), non-volatile data storage (e.g., Flash memory, a hard disc drive, a solid state drive, erasable programmable read-only memory (EPROM), without limitation). In some examples the processors 802 and the storage 804 may be implemented into a single device (e.g., a semiconductor device product, a system on chip (SOC), without limitation). In some examples the processors 802 and the storage 804 may be implemented into separate devices.

In some examples the machine-executable instructions 808 may include computer-readable instructions (e.g., software code, firmware code). By way of non-limiting example, the computer-readable instructions may be stored by the storage 804, accessed directly by the processors 802, and executed by the processors 802 using at least the logic circuit 806. Also by way of non-limiting example, the computer-readable instructions may be stored on the storage 804, transferred to a memory device (not shown) for execution, and executed by the processors 502 using at least the logic circuit 806. Accordingly, in some examples the logic circuit 508 includes electrically configurable logic circuit 806.

In some examples the machine-executable instructions 808 may describe hardware (e.g., circuitry) to be implemented in the logic circuit 806 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 806 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, the sensing system 124 may include an HDL, an RTL, a GL description, a mask level description, other hardware description, or any combination thereof.

In examples where the machine-executable instructions 808 includes a hardware description (at any level of abstraction), a system (not shown, but including the storage 804) implements the hardware description described by the machine-executable instructions 808. By way of non-limiting example, the processors 802 may include a programmable logic device (e.g., an FPGA or a PLC) and the logic circuit 806 may be electrically controlled to implement circuitry corresponding to the hardware description into the logic circuit 806. Also by way of non-limiting example, the logic circuit 806 may include hard-wired logic manufactured by a manufacturing system (not shown, but including the storage 804) according to the hardware description of the machine-executable instructions 808.

Regardless of whether the machine-executable instructions 808 includes computer-readable instructions or a hardware description, the logic circuit 806 is adapted to perform the functional elements described by the machine-executable instructions 808 when implementing the functional elements of the machine-executable instructions 808. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: An apparatus, comprising: a first memory associated with a first address space; a second memory associated with a second address space, wherein the first address space and the second address space include like addresses; a processor including circuitry to disable execution of instructions from first memory and enable execution of instructions from second memory at least partially responsive to an internal signal of a microcontroller; and a peripheral device to set the internal signal.

Example 2: The apparatus according to Example 1, comprising: a register to store an address of a starting instruction of the instructions at the second memory, wherein the processor to update a program counter of the processor with the address when it enables execution of instructions form the second memory.

Example 3: The apparatus according to any of Examples 1 and 2, wherein the register is a memory mapped register accessible to the processor.

Example 4: The apparatus according to any of Examples 1 through 3, wherein the peripheral device includes a logic circuit to set the internal signal.

Example 5: The apparatus according to any of Examples 1 through 4, wherein the logic circuit includes a control bit, and a value of the internal signal is responsive to a write operation to the control bit.

Example 6: The apparatus according to any of Examples 1 through 5, wherein the first memory is a program memory and the second memory is a data memory.

Example 7: The apparatus according to any of Examples 1 through 6, wherein the first memory is a Flash memory and the second memory is an SRAM.

Example 8: The apparatus according to any of Examples 1 through 7, wherein the program memory and the data memory are in physically separate memories.

Example 9: A method, comprising: executing, by a processor of a microcontroller system, instructions fetched from a first memory of the microcontroller system; setting the processor of the microcontroller to execute instructions from a second memory of the microcontroller at least partially responsive to a state of an internal signal of the microcontroller; and executing, by the processor of the microcontroller system, instructions fetched from the second memory of the microcontroller system.

Example 10: The method according to Example 9, wherein setting the processor of the microcontroller to execute instructions from the second memory of the microcontroller comprises: executing a specific instruction fetched from the first memory, the specific instruction designed to trigger memory source change; setting the internal signal of the microcontroller in response to execution of a specific instruction designed to trigger memory source change; and enabling fetching instructions from the second memory at least partially responsive to the set internal signal.

Example 11: The method according to any of Examples 9 and 10, comprising: updating a program counter of the processor with an address of a starting instruction stored at the second memory, the address of the starting instruction stored at a register of the microcontroller.

Example 12: The method according to any of Examples 9 through 11, wherein the setting the internal signal of the microcontroller comprises: setting the internal signal via a peripheral of the microcontroller.

Example 13: The method according to any of Examples 9 through 12, wherein the setting the internal signal of the microcontroller comprises: writing to a strobe bit at a peripheral device.

Example 14: The method according to any of Examples 9 through 13, comprising: setting the processor of the microcontroller to execute instructions from the first memory of the microcontroller at least partially responsive to the state of the internal signal of the microcontroller or completing execution of code stored at the second memory; and executing, by the processor of the microcontroller system, instructions fetched from the first memory of the microcontroller system.

Example 15: The method according to any of Examples 9 through 14, wherein enabling fetching instructions from the second memory comprises: setting a fetch control signal that is utilized as a selection signal by a multiplexer that receives an output of a program memory of the first memory at a first input and an output of a data memory of the second memory at a second input.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus, comprising:
a first memory associated with a first address space;
a second memory associated with a second address space, wherein the first address space and the second address space include like addresses;
a processor including circuitry to disable execution of instructions from first memory and enable execution of instructions from second memory at least partially responsive to an internal signal of a microcontroller; and
a peripheral device to set the internal signal.

2. The apparatus of claim 1, comprising:
a register to store an address of a starting instruction of the instructions at the second memory,
wherein the processor to update a program counter of the processor with the address when it enables execution of instructions form the second memory.

3. The apparatus of claim 2, wherein the register is a memory mapped register accessible to the processor.

4. The apparatus of claim 1, wherein the peripheral device includes a logic circuit to set the internal signal.

5. The apparatus of claim 4, wherein the logic circuit includes a control bit, and a value of the internal signal is responsive to a write operation to the control bit.

6. The apparatus of claim 1, wherein the first memory is a program memory and the second memory is a data memory.

7. The apparatus of claim 6, wherein the first memory is a Flash memory and the second memory is an SRAM.

8. The apparatus of claim 6, wherein the program memory and the data memory are in physically separate memories.

9. A method, comprising:
executing, by a processor of a microcontroller system, instructions fetched from a first memory of the microcontroller system;
setting the processor of the microcontroller to execute instructions from a second memory of the microcontroller at least partially responsive to a state of an internal signal of the microcontroller; and
executing, by the processor of the microcontroller system, instructions fetched from the second memory of the microcontroller system.

10. The method of claim 9, wherein setting the processor of the microcontroller to execute instructions from the second memory of the microcontroller comprises:
executing a specific instruction fetched from the first memory, the specific instruction designed to trigger memory source change;
setting the internal signal of the microcontroller in response to execution of a specific instruction designed to trigger memory source change; and
enabling fetching instructions from the second memory at least partially responsive to the set internal signal.

11. The method of claim 10, comprising:
updating a program counter of the processor with an address of a starting instruction stored at the second memory, the address of the starting instruction stored at a register of the microcontroller.

12. The method of claim 10, wherein the setting the internal signal of the microcontroller comprises:
setting the internal signal via a peripheral of the microcontroller.

13. The method of claim 10, wherein the setting the internal signal of the microcontroller comprises:
writing to a strobe bit at a peripheral device.

14. The method of claim 9, comprising:
setting the processor of the microcontroller to execute instructions from the first memory of the microcontroller at least partially responsive to the state of the internal signal of the microcontroller or completing execution of code stored at the second memory; and
executing, by the processor of the microcontroller system, instructions fetched from the first memory of the microcontroller system.

15. The method of claim 9, wherein enabling fetching instructions from the second memory comprises:
setting a fetch control signal that is utilized as a selection signal by a multiplexer that receives an output of a program memory of the first memory at a first input and an output of a data memory of the second memory at a second input.
